(19) United States
(12) Patent Application Publication
(10) Pub. No.: US 2024/0284555 A1
(43) Pub. Date: Aug. 22, 2024

(54) COMMUNICATION METHOD AND USER EQUIPMENT

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/634,179

(22) Filed: Apr. 12, 2024

Related U.S. Application Data
(63) Continuation of application No. PCT/JP2022/038122, filed on Oct. 12, 2022.
(60) Provisional application No. 63/262,459, filed on Oct. 13, 2021.

(51) Int. Cl. H04W 76/38; H04W 76/40

(52) U.S. Cl. CPC H04W 76/38; H04W 76/40

(57) ABSTRACT

A communication method is a method performed by a user equipment in a mobile communication system for providing a multicast broadcast service (MBS). The communication method includes receiving, from a base station, configuration information by which a multicast traffic channel (MTCH) associated with an MBS radio bearer (MRB) is configured, and determining, based on the configuration information, whether a type of a session transmitted on the MTCH is a multicast session or a broadcast session.

### RELATED APPLICATIONS

The present application is a continuation based on PCT Application No. PCT/JP2022/038122, filed on Oct. 12, 2022, which claims the benefit of U.S. Provisional Patent Application No. 63/262,459 filed on Oct. 13, 2021. The content of which is incorporated by reference herein in their entirety.

### TECHNICAL FIELD

The present disclosure relates to a communication method and a user equipment used in a mobile communication system.

### BACKGROUND OF INVENTION

In 3rd Generation Partnership Project (3GPP) standards, technical specifications of New Radio (NR) being radio access technology of the fifth generation (5G) have been defined. NR has features such as high speed, large capacity, high reliability, and low latency, in comparison to Long Term Evolution (LTE) being radio access technology of the fourth generation (4G). In 3GPP, there have been discussions for establishing technical specifications of multicast and broadcast services (MBS) of 5G/NR (for example, see Non-Patent Document 1).

### CITATION LIST

### Non-Patent Literature

Non-Patent Document 1: 3GPP Contribution: RP-201038, “WID revision: NR Multicast and Broadcast Services”

### SUMMARY

In a first aspect, a communication method is a method performed by a user equipment in a mobile communication system for providing a multicast broadcast service (MBS). The communication method includes receiving, from a base station, configuration information by which a multicast traffic channel (MTCH) associated with an MBS radio bearer (MRB) is configured, and determining, based on the configuration information, whether a type of a session transmitted on the MTCH is a multicast session or a broadcast session.

In a second aspect, a user equipment is a user apparatus in a mobile communication system for providing a multicast broadcast service (MBS). The user equipment includes a processor. The processor executes processing of receiving, from a base station, configuration information by which a multicast traffic channel (MTCH) associated with an MBS radio bearer (MRB) is configured, and processing of determining, based on the configuration information, whether a type of a session transmitted on the MTCH is a multicast session or a broadcast session.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating an overview of MBS traffic delivery according to an embodiment.

FIG. 7 is a diagram illustrating delivery modes according to an embodiment.

FIG. 8 is a diagram illustrating an example of internal processing related to MBS reception of the UE according to an embodiment.

FIG. 9 is a diagram illustrating another example of internal processing related to the MBS reception of the UE according to an embodiment.

FIG. 10 is a diagram illustrating an operation of the UE related to data inactivity monitoring according to a first embodiment.

FIG. 11 is a diagram illustrating an operation of a mobile communication system according to a first embodiment.

FIG. 12 is a diagram illustrating an operation of a mobile communication system according to a second embodiment.

FIG. 13 is a diagram illustrating a configuration example of an RRCSystemInfoRequest message according to the second embodiment.

### DESCRIPTION OF EMBODIMENTS

A mobile communication system according to an embodiment is described with reference to the drawings. In the description of the drawings, the same or similar parts are denoted by the same or similar reference signs.

5G/NR multicast and broadcast services are desired to provide enhanced services compared to 4G/LTE multicast and broadcast services.

In view of this, the present disclosure provides a communication method and a user equipment for enabling implementation of enhanced multicast and broadcast services.

### First Embodiment

### Configuration of Mobile Communication System

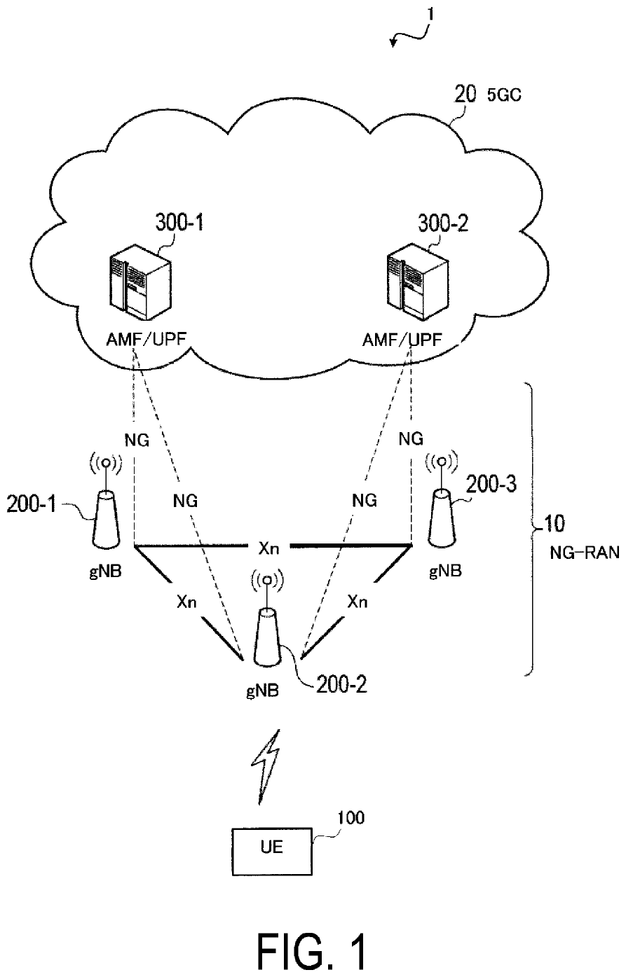

FIG. 1 is a diagram illustrating a configuration of a mobile communication system according to a first embodiment. The mobile communication system 1 complies with the 5th Generation System (5GS) of the 3GPP standard. The description below takes the 5GS as an example, but a Long Term Evolution (LTE) system or a sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), or a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

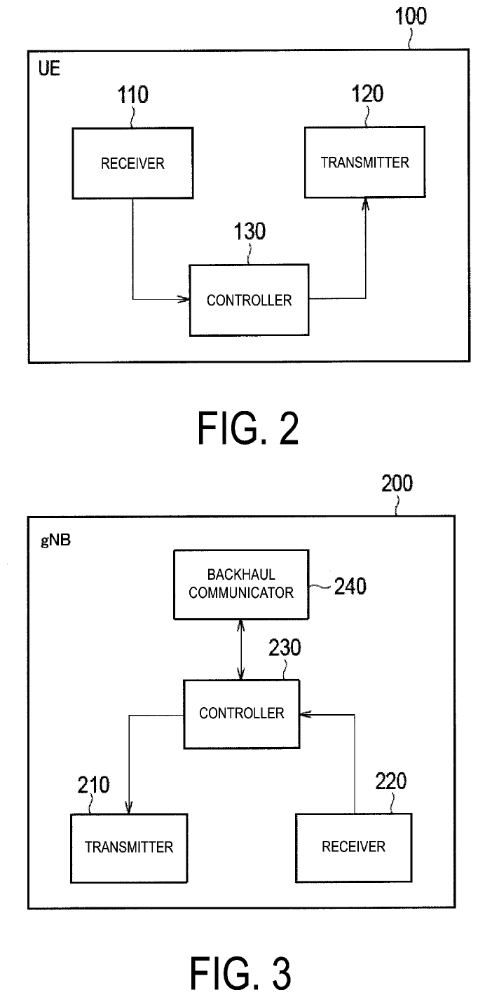

FIG. 2 is a diagram illustrating a configuration of the UE 100 (user equipment) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processes in the UE 100. Such processes include processes of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processes in the gNB 200. Such processes include processes of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

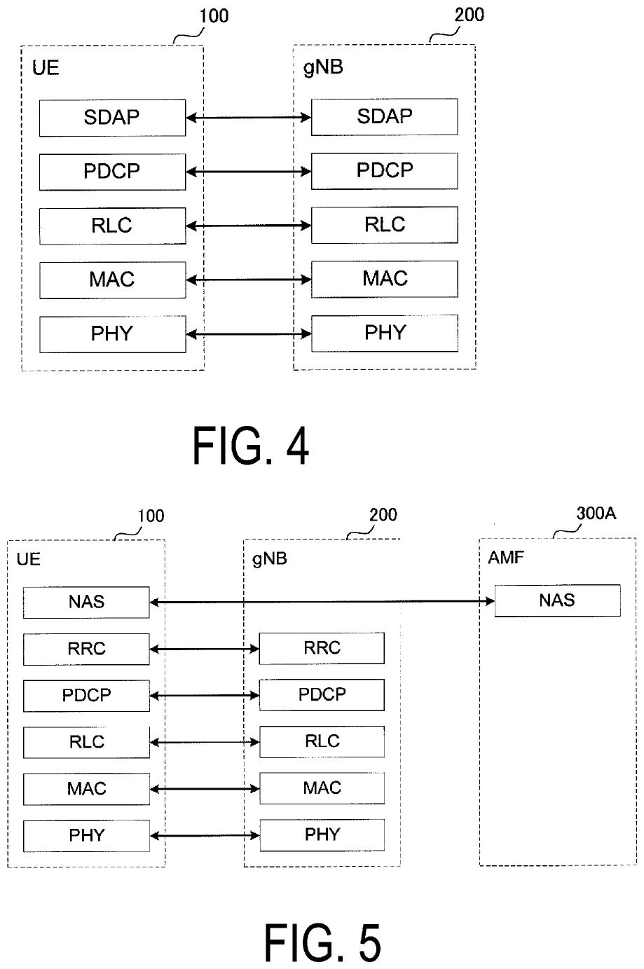

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs preferential control of data, retransmission processing using a hybrid ARQ (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, modulation and coding schemes (MCSs)) in the uplink and the downlink, and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of QoS control by a core network and a radio bearer as the unit of QoS control by an Access Stratum (AS). Note that, when the RAN is connected to the EPC, the SDAP need not be provided.

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel depending on establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### Overview of MBS

An overview of the MBS according to the first embodiment will be described. The MBS is a service in which the NG-RAN 10 can provide broadcast or multicast, i.e., Point To Multipoint (PTM) data transmission to the UE 100. Note that assumed use cases (service types) of the MBS include public safety communication, mission critical communication, Vehicle to Everything (V2X) communication, IPv4 or IPv6 multicast delivery, IPTV, group communication, and software delivery.

A broadcast service provides a service to every UE 100 within a particular service area for an application not requiring highly reliable QoS. An MBS session used for the broadcast service is referred to as a broadcast session.

A multicast service provides a service not to every UE 100, but to a group of UEs 100 participating in the multicast service (multicast session). An MBS session used for the multicast service is referred to as a multicast session. The multicast service can provide the same content to the group of UEs 100 through a method with higher radio efficiency than the broadcast service.

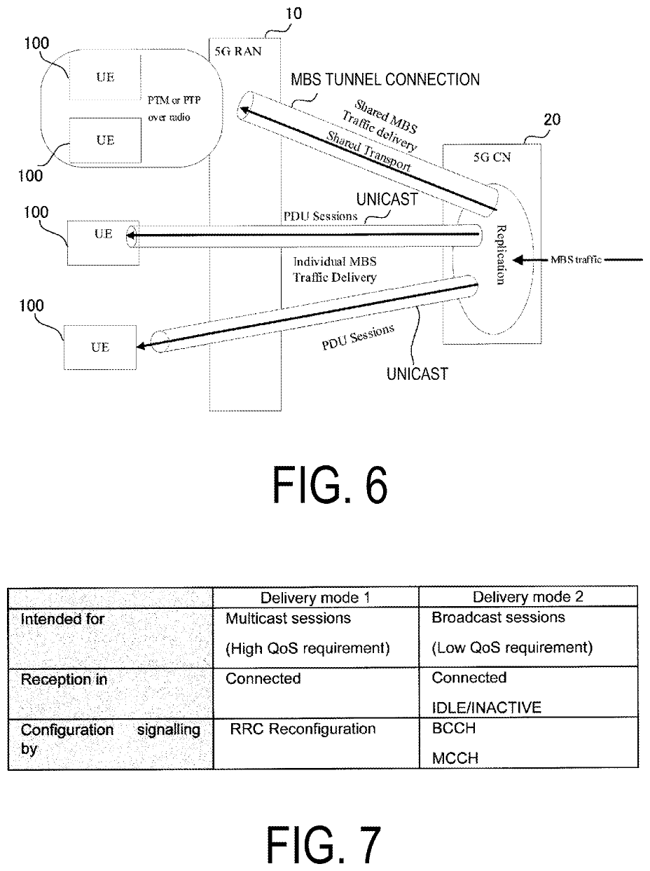

FIG. 6 is a diagram illustrating an overview of MBS traffic delivery according to the first embodiment.

MBS traffic (MBS data) is delivered from a single data source (application service provider) to a plurality of UEs. The 5G CN (5GC) 20, which is a 5G core network, receives the MBS data from the application service provider and performs Replication of the MBS data to deliver the resultant.

From the perspective of the 5GC 20, two multicast delivery methods are possible: 5GC Shared MBS Traffic delivery and 5GC Individual MBS Traffic delivery.

In the 5GC individual MBS traffic delivery method, the 5GC 20 receives a single copy of MBS data packets and delivers individual copies of these MBS data packets to the individual UEs 100 via PDU sessions of the individual UEs 100. Thus, one PDU session for each UE 100 needs to be associated with a multicast session.

In the 5GC shared MBS traffic delivery method, the 5GC 20 receives a single copy of MBS data packets and delivers the single copy of the MBS packets to a RAN node (i.e., the gNB 200). The gNB 200 receives the MBS data packets via MBS tunnel connection, and delivers those to one or more UEs 100.

From the perspective of the RAN (5G RAN) 10, two delivery methods are possible for radio transmission of the MBS data in the 5GC shared MBS traffic delivery method: a Point-to-Point (PTP) delivery method and a Point-to-Multipoint (PTM) delivery method. PTP means unicast, and PTM means multicast and broadcast.

In the PTP delivery method, the gNB 200 wirelessly delivers the individual copies of the MBS data packets to the individual UEs 100. On the other hand, in the PTM delivery method, the gNB 200 wirelessly delivers the single copy of the MBS data packets to a group of the UEs 100. The gNB 200 can dynamically determine whether to use the PTM or PTP delivery method as a method for delivering the MBS data to one UE 100.

The PTP and PTM delivery methods are mainly related to the user plane. Modes for controlling the MBS data delivery include two delivery modes: a first delivery mode and a second delivery mode.

FIG. 7 is a diagram illustrating the delivery modes according to the first embodiment.

The first delivery mode (Delivery mode 1 (DM1)) is a delivery mode that can be used by the UE 100 in the RRC connected state, and is a delivery mode for high QoS requirements.

The first delivery mode is used for multicast sessions among MBS sessions. Note that the first delivery mode may be used for broadcast sessions. The first delivery mode may be available to the UE 100 in the RRC idle state or the RRC inactive state.

MBS reception configuration in the first delivery mode is performed through UE-dedicated signaling. For example, the MBS reception configuration in the first delivery mode is performed through an RRC Reconfiguration message (or an RRC Release message), which is an RRC message unicast from the gNB 200 to the UE 100.

The MBS reception configuration includes MBS traffic channel configuration information (hereinafter referred to as “MTCH configuration information”) about configuration of an MBS traffic channel transmitting MBS data. The MTCH configuration information includes MBS session information (including an MBS session identifier described below) relating to an MBS session and scheduling information of an MBS traffic channel corresponding to the MBS session. The scheduling information of an MBS traffic channel may include discontinuous reception (DRX) configuration of the MBS traffic channel. The discontinuous reception configuration may include at least one parameter of a timer value (On Duration Timer) for defining an on-period (On Duration: reception period), a timer value (Inactivity Timer) for extending the on-period, a scheduling interval or a DRX cycle (Scheduling Period, DRX Cycle), an offset value (Start Offset, DRX Cycle Offest) of a start subframe for scheduling or a DRX cycle, a start delay slot value (Slot Offset) of an on-period timer, a timer value (Retransmission Timer) for defining a maximum time until retransmission, and a timer value (HARQ RTT Timer) for defining a minimum interval until DL assignment of HARQ retransmission.

Note that the MBS traffic channel is a type of logical channel and may be referred to as an MTCH. The MBS traffic channel is mapped to a downlink shared channel (DL-SCH) that is a type of transport channel.

The second delivery mode (Delivery mode 2 (DM2)) is a delivery mode that can be used not only by the UE 100 in the RRC connected state, but also by the UE 100 in the RRC idle state or the RRC inactive state, and is a delivery mode for low QoS requirements. The second delivery mode is used for broadcast sessions among MBS sessions. However, the second delivery mode may also be applicable to multicast sessions.

An MBS reception configuration in the second delivery mode is performed through broadcast signaling. For example, the MBS reception configuration in the second delivery mode is performed using a logical channel transmitted from the gNB 200 to the UE 100 through broadcast, for example, a broadcast control channel (BCCH) and/or a multicast control channel (MCCH). The UE 100 can receive the BCCH and the MCCH, using a dedicated RNTI defined in technical specifications in advance, for example. The RNTI for BCCH reception may be an SI-RNTI, and the RNTI for MCCH reception may be an MCCH-RNTI.

In the second delivery mode, the UE 100 may receive the MBS data in the following three procedures. Firstly, the UE 100 receives MCCH configuration information on an SIB (MBS SIB) transmitted from the gNB 200 on the BCCH. Secondly, the UE 100 receives the MCCH from the gNB 200, based on the MCCH configuration information. On the MCCH, MTCH configuration information is transmitted. Thirdly, the UE 100 receives the MTCH (MBS data), based on the MTCH configuration information. The MTCH configuration information and/or the MCCH configuration information may be hereinafter referred to as the MBS reception configuration.

In the first delivery mode and the second delivery mode, the UE 100 may receive the MTCH, using a group RNTI (G-RNTI) assigned from the gNB 200. The G-RNTI corresponds to an RNTI for MTCH reception. The G-RNTI may be included in the MBS reception configuration (MTCH configuration information).

The network can provide different MBS services for different MBS sessions. The MBS session is identified by at least one selected from the group consisting of a Temporary Mobile Group Identity (TMGI), a source-specific IP multicast address (which consists of a source unicast IP address, such as an application function and an application server, and an IP multicast address indicating a destination address), a session identifier, and a G-RNTI. At least one selected from the group consisting of the TMGI, the source specific IP multicast address, and the session identifier is referred to as an MBS session identifier. The TMGI, the source-specific IP multicast address, the session identifier, and the G-RNTI are collectively referred to as MBS session information.

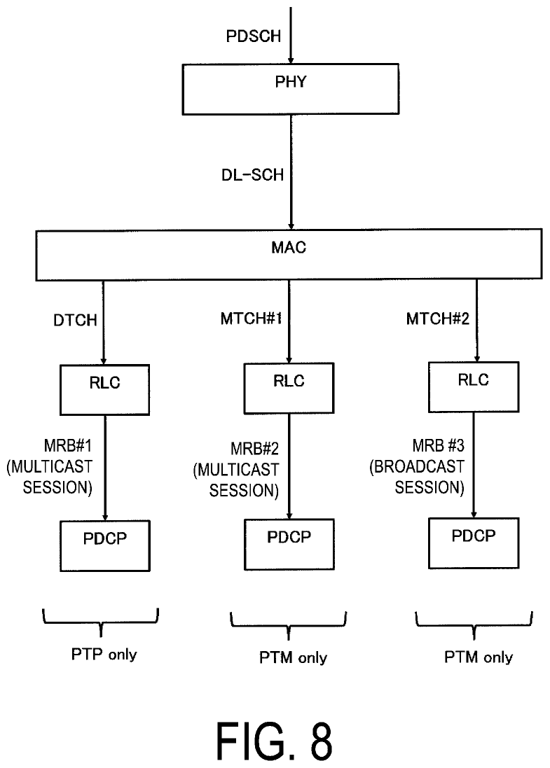

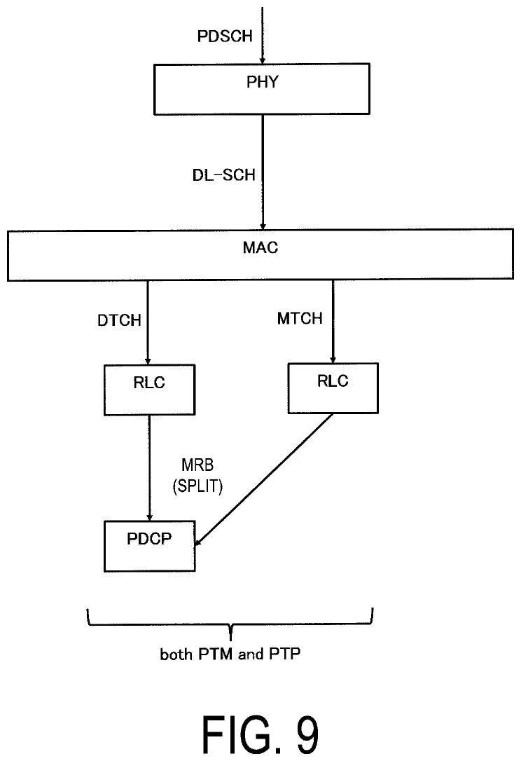

FIG. 8 is a diagram illustrating an example of internal processing related to the MBS reception of the UE 100 according to the first embodiment. FIG. 9 is a diagram illustrating another example of internal processing related to the MBS reception of the UE 100 according to the first embodiment.

One MBS radio bearer (MRB) is one radio bearer for transmitting a multicast session or a broadcast session. In other words, the MRB may be associated with a multicast session in some cases or may be associate with a broadcast session in some other cases.

The gNB 200 configures the UE 100 with the MRB and a corresponding logical channel (e.g., MTCH) by RRC signaling. An MRB configuration procedure may be separated from a data radio bearer (DRB) configuration procedure. The RRC signaling allows one MRB to be configured with “PTM only”, “PTP only”, or “both PTM and PTP”. The type of the MRB may be changed by the RRC signaling.

FIG. 8 illustrates an example in which MRB #1 is associated with a multicast session and a dedicated traffic channel (DTCH), MRB #2 is associated with a multicast session and MTCH #1, and MRB #3 is associated with a broadcast session and MTCH #2. In other words, the MRB #1 is a PTP only MRB, the MRB #2 is a PTM only MRB, and the MRB #3 is a PTM only MRB. Note that the DTCH is scheduled using a cell RNTI (C-RNTI). The MTCH is scheduled using the G-RNTI.

The PHY layer of the UE 100 processes user data (received data) received on the PDSCH, which is one of physical channels, and routes the processed user data to the downlink shared channel (DL-SCH), which is one of transport channels. The MAC layer (MAC entity) of the UE 100 processes the data received on the DL-SCH and routes the received data to a corresponding logical channel (corresponding RLC entity) based on a logical channel identifier (LCID) included in the header (MAC header) included in the received data.

FIG. 9 illustrates an example in which the MRB associated with the multicast session is associated with the DTCH and the MTCH. Specifically, one MRB is split into two legs, one leg is associated with the DTCH, and the other leg is associated with the MTCH. The two legs are combined at the PDCP layer (PDCP entity). In other words, the MRB is an MRB for both PTM and PTP. Such an MRB may be referred to as a split MRB.

### Data Inactivity Monitoring

Data Inactivity Monitoring according to the first embodiment will be described. The UE 100 in the RRC connected state performs data inactivity monitoring when the UE 100 is configured with a data inactivity timer (dataInactivityTimer) by the gNB 200. Data inactivity monitoring is processing for releasing the RRC connection of the UE 100 depending on a certain period of inactivity in which communication with the gNB 200 is not performed. The UE 100 starts or restarts the data inactivity timer each time the UE 100 communicates with the gNB 200. When the data inactivity timer expires, the UE 100 autonomously releases the RRC connection (i.e., autonomously transitions to the RRC idle state).

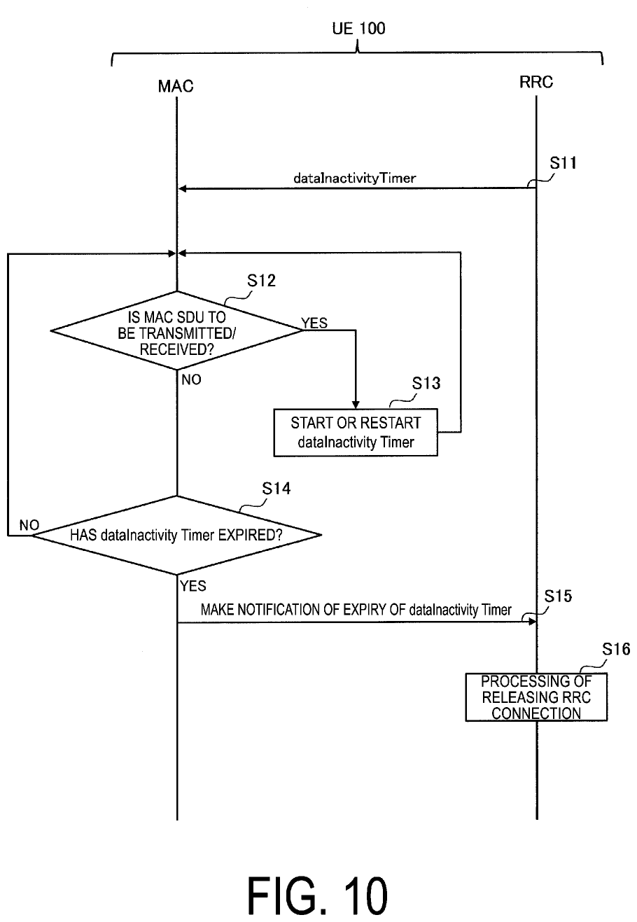

FIG. 10 is a diagram illustrating an operation of the UE 100 related to data inactivity monitoring according to the first embodiment.

In step S11, the RRC entity of UE 100 configures a data inactivity timer (dataInactivityTimer) for the MAC entity.

In step S12, the MAC entity of the UE 100 determines whether an MAC SDU has been transmitted or received. For example, the MAC entity of the UE 100 determines whether a MAC SDU has been received for the DTCH, a dedicated control channel (DCCH), or a common control channel (CCCH). The MAC entity of the UE 100 determines whether a MAC SDU has been transmitted for the DTCH or DCCH.

In the first embodiment, in step S12, the MAC entity of the UE 100 also determines whether a MAC SDU has been received for the MTCH. However, the MAC entity of the UE 100 applies data inactivity monitoring only to the MTCH transmitting a multicast session and does not apply data inactivity monitoring to the MTCH transmitting a broadcast session. In other words, in step S12, the MAC entity of UE 100 determines whether a MAC SDU has been received for the MTCH associated with the multicast session, but does not determine whether a MAC SDU has been received for the MTCH associated with the broadcast session.

For YES in step S12, then in step S13, the MAC entity of the UE 100 starts or restarts the data inactivity timer (dataInactivityTimer). Subsequently, the MAC entity returns processing to step S12.

For NO in step S12, then in step S14, the MAC entity of the UE 100 determines whether the data inactivity timer (dataInactivityTimer) has expired. When a period during which transmission or reception of a MAC SDU does not occur for a logical channel to which data inactivity monitoring is applied continues for a timer value of the data inactivity timer, the data inactivity timer expires.

When the data inactivity timer expires (step S14: YES), in step S15, the MAC entity of the UE 100 notifies the RRC entity of the expiration of the data inactivity timer.

In step S16, the RRC entity of the UE 100 performs RRC connection release processing depending on the expiration of the data inactivity timer. As a result, the UE 100 transitions to the RRC idle state.

### Operation of Mobile Communication System

An operation of the mobile communication system 1 according to the first embodiment will be described.

As described above, the MAC entity of the UE 100 applies data inactivity monitoring only to the MTCH (MRB) transmitting a multicast session and does not apply data inactivity monitoring to the MTCH (MRB) transmitting a broadcast session. Therefore, the UE 100 configured with the MTCH (MRB) needs to be able to determine whether the type of the session transmitted on the MTCH (MRB) is a multicast session or a broadcast session.

The first embodiment describes an operation for the UE 100 to determine whether the type of the session transmitted by the configured MTCH (MRB) is a multicast session or a broadcast session. Hereinafter, the MTCH (or MRB) transmitting a multicast session is referred to as a multicast MTCH (or multicast MRB). The MTCH (or MRB) transmitting the broadcast session is referred to as a broadcast MTCH (or broadcast MRB).

In the first embodiment, the UE 100 receives, from the gNB 200, configuration information (MTCH configuration information) for configuring the multicast traffic channel (MTCH) associated with the MBS radio bearer (MRB). The UE 100 determines whether the type of the session transmitted with the MRB or on the MTCH is a multicast session or a broadcast session, based on the MTCH configuration information or the MBS data transmitted on the MTCH. This enables appropriate determination of whether the configured MTCH (MRB) is a multicast MTCH (multicast MRB) or a broadcast MTCH (broadcast MRB).

Note that determination of whether the configured MTCH (MRB) is a multicast MTCH (multicast MRB) or the broadcast MTCH (broadcast MRB) may mean determination of whether data inactivity monitoring is applied to the configured MTCH (MRB). Specifically, determining that the configured MTCH (MRB) is a multicast MTCH (multicast MRB) may mean determining that data inactivity monitoring is applied to the configured MTCH (MRB). Determining that the configured MTCH (MRB) is the broadcast MTCH (broadcast MRB) may mean determining that data inactivity monitoring is not applied to the configured MTCH (MRB).

The UE 100 may determine whether the type of the session transmitted on the MTCH (MRB) is a multicast session or a broadcast session, based on at least one of information included in the MTCH configuration information for configuring the MTCH (MRB), the type of the message transmitting the MTCH configuration information, and the type of the channel transmitting the MTCH configuration information.

When the UE 100 is in the RRC connected state and the determined session type is a multicast session, the UE 100 applies data inactivity monitoring to the configured MTCH. Here, whether the MTCH is to be subjected to data inactivity monitoring may be determined by the RRC entity of the UE 100. The RRC entity may notify the MAC entity of information indicating a result of the determination. As described above, data inactivity monitoring is performed by the MAC entity. Accordingly, the RRC entity determines the type of the session (in other words, whether data inactivity monitoring is applied) for each MTCH (MRB), and notifies the MAC entity of the result. Thus, the MAC entity can appropriately recognize, for each MTCH, whether data inactivity monitoring is applied.

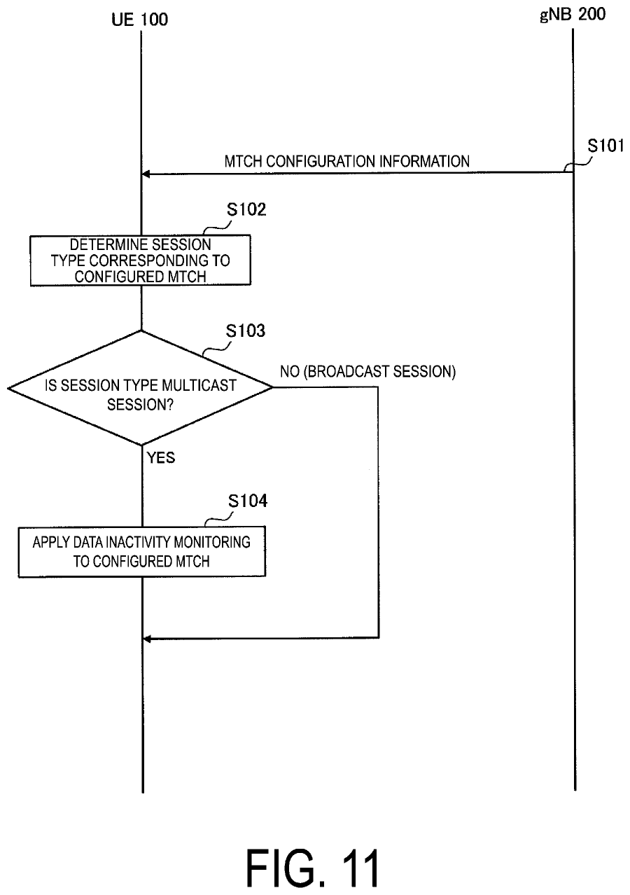

FIG. 11 is a diagram illustrating an operation of the mobile communication system 1 according to the first embodiment.

In step S101, the gNB 200 transmits, to the UE 100, an RRC Reconfiguration message or the MCCH including the MTCH configuration information. The UE 100 receives the MTCH configuration information. Note that although the UE 100 is assumed to be in the RRC connected state, the UE 100 may be in the RRC idle state or in the RRC inactive state.

In step S102, the RRC entity of the UE 100 determines whether the type of the session transmitted on the configured MTCH (MRB) is a multicast session or a broadcast session, based on the MTCH configuration information received in step S101 or the MBS data transmitted on the MTCH. The UE 100 may determine whether to apply data inactivity monitoring to the configured MTCH (MRB), based on the MTCH configuration information received in step S101 or the MBS data transmitted on the MTCH. When configured with a plurality of MTCHs, the UE 100 performs the determination for each configured MTCH. The RRC entity of the UE 100 may notify a lower layer (e.g., the MAC entity) of the determined session type and/or the information indicating whether data inactivity monitoring is applied.

The RRC entity in the UE 100 may use any one of the following first to fifth determination methods as a method for performing such determination.

### First Determination Method

The MTCH configuration information includes, for each MTCH or for each G-RNTI, information indicating whether the MTCH is a multicast MTCH or a broadcast MTCH or information indicating whether data inactivity monitoring is applied to the MTCH. The RRC entity of the UE 100 determines, based on the information included in the MTCH configuration information, whether the type of the session transmitted on the MTCH is a multicast session or a broadcast session (in other words, whether data inactivity monitoring is applied to the MTCH (MRB)).

### Second Determination Method

The MTCH configuration information includes an MBS session identifier (e.g., TMGI) for each MTCH. The NAS layer of the UE 100 notifies the AS layer of an MBS session identifier (TMGI) with which the UE 100 has performed multicast session join. The AS layer of UE 100 compares the MBS session identifier (TMGI) notified from the NAS layer with the MBS session identifier (TMGI) included in the MTCH configuration information received in step S101, and determines, as a multicast MTCH (multicast MRB), the MTCH (MRB) corresponding to the MBS session identifier (TMGI) matching the MBS session identifier (TMGI) notified from the NAS layer.

### Third Determination Method

The MTCH configuration information includes a HARQ feedback configuration associated with the MTCH. The UE 100 determines that data inactivity monitoring is not applied to the MTCH for which the HARQ feedback is not configured, and determines that data inactivity monitoring is applied to the MTCH for which the HARQ feedback (e.g., PUCCH resources for the HARQ feedback) is not configured. For the UE 100 configured with the HARQ feedback for MBS reception, based on the HARQ feedback, the gNB 200 can recognize, by data inactivity monitoring, whether the UE 100 has transitioned to the RRC idle state.

### Fourth Determination Method

The MTCH configuration information is included in a first information element (e.g., RadioBearerConfig or mrb-ToAddModList) in the RRC Reconfiguration message transmitted from the gNB 200 to the UE 100 on the DL-DCCH. Alternatively, the MTCH configuration information is included in a second information element (e.g., MBS broadcast Configuration) transmitted from the gNB 200 to the UE 100 on the MCCH. When the MTCH configuration information is transmitted through any one of the DL-DCCH, the RRC Reconfiguration message, or the first information element, the UE 100 determines that the type of the session transmitted on the MTCH corresponding to the MTCH configuration information is a multicast session (i.e., data inactivity monitoring is applied to the MTCH). On the other hand, when the MTCH configuration information is transmitted through one of the MCCH or the second information element, the UE 100 determines that the type of the session transmitted on the MTCH corresponding to the MTCH configuration information is a broadcast session (i.e., data inactivity monitoring is not applied to the MTCH).

### Fifth Determination Method

The MTCH configured in step S101 transfers the MBS data to the UE 100. Here, the MAC PDU constituting the MBS data may include, in a header of the MAC PDU, information for identifying multicast/broadcast. Based on the information included in the header of the MAC PDU, the UE 100 may determine whether the type of the session transmitted on the MTCH is a multicast session or a broadcast session (i.e., whether to apply data inactivity monitoring to the MTCH).

When the session type determined in step S102 is a multicast session (step S103: YES), the MAC entity of the UE 100 applies data inactivity monitoring to the MTCH configured in step S101. On the other hand, when the session type determined in step S102 is a broadcast session (step S103: NO), data inactivity monitoring is not applied to the MTCH configured in step S101.

Note that the UE 100 may determine a logical channel ID (LCID) space to which the LCID allocated to the configured MTCH belongs, by using any one of the first to fifth determination methods described above. A common LCID space is used for the PTP for multicast sessions and the DTCH/DRB for unicast sessions, but a reserved LCID (different from the LCID space of the DTCH/DRB for unicast sessions) is used for the PTM/MTCH for broadcast sessions. Therefore, the UE 100 can determine whether the MTCH is for multicast/broadcast (whether data inactivity monitoring is applied), based on the LCID space. Accordingly, the UE 100 may determine whether the type of the session transmitted on the MTCH is a multicast session or a broadcast session (i.e., whether to apply data inactivity monitoring to the MTCH) in consideration of the specified LCID space.

### Second Embodiment

A second embodiment will be described mainly regarding differences from the first embodiment described above.

The second embodiment assumes the second delivery mode (Delivery mode 2) described above. In the second delivery mode, the gNB 200 may provide the MBS SIB and/or the MCCH to the UE 100 on demand (i.e., depending on a request from the UE 100). To be more specific, instead of always transmitting the MBS SIB and/or the MCCH, the gNB 200 transmits (broadcasts) the MBS SIB and/or the MCCH only when requested by the UE 100. This enables a reduction in radio resources and power consumption for transmitting the MBS SIB and/or the MCCH.

Here, when on-demand transmission is applied to both the MBS SIB and the MCCH, the UE 100 may need to separately transmit, to the gNB 200, a transmission request for the MBS SIB and a transmission request for the MCCH. In this case, two transmission requests are made, which increases the consumption of radio resources and power consumption. The second embodiment introduces a new mechanism of a single transmission request for requesting both transmission of the MBS SIB and transmission of the MCCH.

In the second embodiment, the UE 100 first transmits, to the gNB 200, a single transmission request for requesting both transmission of the MBS SIB and transmission of the MCCH. Second, the UE 100 receives the MBS SIB transmitted from the gNB 200 depending on the single transmission request. Third, based on the MBS SIB, the UE 100 receives the MCCH transmitted from the gNB 200 depending on the single transmission request. Thus, even when on-demand transmission is applied to both the MBS SIB and the MCCH, the UE 100 need not separately transmit, to the gNB 200, a transmission request for the MBS SIB and a transmission request for the MCCH. Therefore, the consumption of radio resources and power consumption can be reduced.

After transmitting the single transmission request, the UE 100 receives the MBS SIB, and may then start an operation for receiving the MCCH. After transmitting the single transmission request, the UE 100 starts an operation for receiving the MBS SIB (e.g., monitoring the MBS SIB) and does not start an operation for receiving the MCCH (e.g., monitoring the MCCH). Then, after receiving the MBS SIB, the UE 100 starts an operation for receiving the MCCH. Thus, power consumption associated with MCCH reception can be reduced.

The UE 100 may determine whether to request at least one of transmission of the MBS SIB or transmission of the MCCH. Depending on determining to request both the transmission of the MBS SIB and the transmission of the MCCH, the UE 100 may transmit, to the gNB 200, a single transmission request for requesting both transmission of the MBS SIB and transmission of the MCCH. On the other hand, depending on determination to request only the transmission of the MBS SIB, the UE 100 may transmit, to the gNB 200, a transmission request for requesting only the transmission of the MBS SIB. Depending on determination to request only the transmission of the MCCH, the UE 100 may transmit, to the gNB 200, a transmission request for requesting only the transmission of the MCCH.

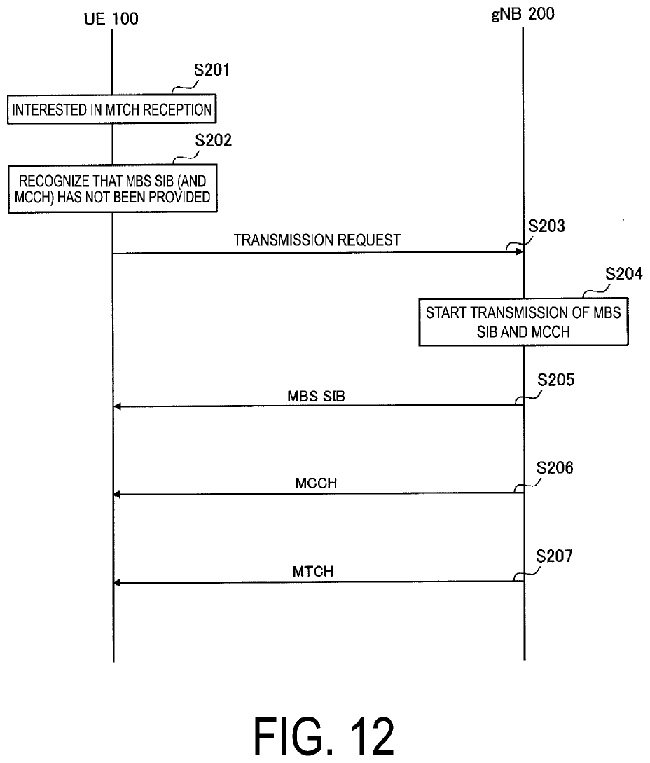

FIG. 12 is a diagram illustrating an operation of the mobile communication system 1 according to the second embodiment.

In step S201, the UE 100 is interested in MBS reception (specifically, MTCH reception).

In step S202, the UE 100 recognizes that the gNB 200 is not broadcasting the MBS SIB (and the MCCH). For example, when the UE 100 receives an SIB Type 1 from the gNB 200 and the SI scheduling information in the SIB Type 1 indicates that the gNB 200 the MBS SIB (and the MCCH) the gNB 200 is not broadcasting the MBS SIB (and the MCCH), the gNB 200 determines that the gNB 200 is not broadcasting the MBS SIB (and the MCCH) and that the MBS SIB (and the MCCH) is provided on demand.

In step S203, the UE 100 transmits, to the gNB 200, a single transmission request for requesting both transmission of the MBS SIB and transmission of the MCCH. The single transmission request may be a random access preamble transmitted using a physical random access channel (PRACH) resource prepared in a dedicated manner to request transmission of at least the MBS SIB. Such a dedicated PRACH resource may be a time and frequency resource, or may be a preamble sequence. Alternatively, the single transmission request may be an RRC message (RRCSystemInfoRequest message) including at least an information element for requesting transmission of the MBS SIB.

In step S204, upon receiving the single transmission request, the gNB 200 starts to transmit the MBS SIB and the MCCH. After receiving the single transmission request, the gNB 200 may periodically transmit each of the MBS SIB and the MCCH for a certain period of time. The certain period of time may be the same or different for the MBS SIB and the MCCH.

Meanwhile, upon receiving the single transmission request, the UE 100 starts monitoring the MBS SIB. For example, the UE 100 performs reception processing for the PDCCH using a system information RNTI (SI-RNTI) at a reception occasion for the MBS SIB indicated by the SI scheduling information. At this point, the UE 100 need not start monitoring the MCCH.

In step S205, the UE 100 receives the MBS SIB transmitted from the gNB 200. Depending on reception of the MBS SIB, the UE 100 starts MCCH monitoring based on the MCCH configuration information in the received MBS SIB. For example, the UE 100 performs the reception processing for the PDCCH using the MCCH-RNTI at the reception occasion for the MCCH indicated by the MCCH configuration information. The UE 100 may start monitoring the MCCH within a certain period of time after transmitting the transmission request in step S203. The UE 100 may complete the MCCH acquisition within a certain period of time after transmitting the transmission request in step S203. The certain period of time may be provided to the UE 100 from the gNB 200. Note that, in step S205, the UE 100 may start receiving the MCCH immediately after receiving the MBS SIB. For example, the UE 100 may start MCCH reception in a slot in which the MBS SIB is received or a next slot thereof, or may start MCCH reception at a first MCCH reception occasion indicated by the MCCH configuration information in the MBS SIB or before the MCCH reception occasion. Here, the first MCCH reception occasion may be an MCCH reception occasion following the reception of the MBS SIB, or may be a first MCCH reception occasion after an MCCH Modification Boundary. The first MCCH reception occasion may be a first MCCH reception occasion in an SSB (beam) received by the UE 100.

In step S206, the UE 100 receives the MCCH transmitted from the gNB 200. The UE 100 starts monitoring the MTCH based on the MTCH configuration information in the received MCCH. For example, the UE 100 performs reception processing for the PDCCH using the G-RNTI at the reception occasion for the MTCH indicated by the MTCH configuration information.

In step S207, the UE 100 receives the MTCH transmitted from the gNB 200.

Note that, in FIG. 12, the single transmission request for requesting transmission of both the MBS SIB and the MCCH has been described but that the transmission request may involve request for transmission of only one of the MBS SIB or the MCCH. In other words, the MBS SIB/MCCH transmission request may indicate one request pattern selected by the UE 100 from among three patterns of “both MBS SIB and MCCH”, “MBS SIB only”, and “MCCH only”. Note that, when transmitting the transmission request of “MCCH only” to the gNB 200, the UE 100 may start MCCH reception immediately after transmitting the transmission request. For example, the UE 100 may start MCCH reception in the slot in which the MBS SIB is received or the next slot thereof, may start MCCH reception in the slot in which the transmission request is transmitted or the next slot thereof, or may start MCCH reception at the first MCCH reception occasion indicated by the MCCH configuration information in the MBS SIB or before the first MCCH reception occasion. Here, the first MCCH reception occasion may be the MCCH reception occasion following reception of the MBS SIB, may be the MCCH reception occasion following transmission of the transmission request, or may be the first MCCH reception occasion after the MCCH modification boundary. The first MCCH reception occasion may be the first MCCH reception occasion in the SSB (beam) received by the UE 100.

First, a case will be described where an MBS SIB/MCCH transmission request is configured by a random access preamble.

For example, the gNB 200 notifies the UE 100 of a first PRACH resource set corresponding to “both MBS SIB and MCCH”, a second PRACH resource set corresponding to “MBS SIB only”, and a third PRACH resource set corresponding to “MCCH only” through the SIB (for example, the SIB Type 1). The PRACH resource sets are different from one another in time and frequency resources and/or a preamble sequence.

The UE 100 transmits a random access preamble (MBS SIB/MCCH transmission request) by using a PRACH resource set corresponding to the MBS SIB and/or the MCCH which the UE 100 requests transmission based on the content notified by the SIB from the gNB 200. For example, when requesting transmission of “both MBS SIB and MCCH”, the UE 100 transmits the random access preamble using a PRACH resource selected from the first PRACH resource set. When requesting transmission of “MBS SIB only”, the UE 100 transmits the random access preamble using a PRACH resource selected from the second PRACH resource set. When requesting transmission of “MCCH only”, the UE 100 transmits the random access preamble by using a PRACH resource selected from the third PRACH resource set.

Second, a case will be described where the MBS SIB/MCCH transmission request is configured by the RRCSystemInfoRequest message. In this case, the UE 100 transmits to, the gNB 200, the RRCSystemInfoRequest message including an information element indicating one request pattern selected by the UE 100 from among three patterns of “both MBS SIB and MCCH”, “MBS SIB only”, and “MCCH only”.

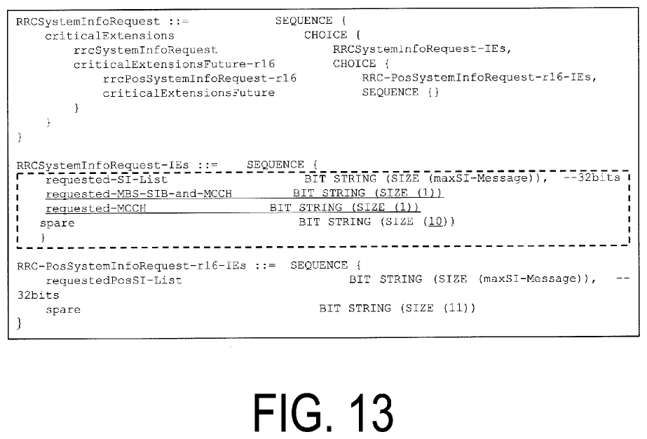

FIG. 13 is a diagram illustrating a configuration example of the RRCSystemInfoRequest message according to the second embodiment.

The RRCSystemInfoRequest message includes at least one of “requested-SI-List” that is a list indicating the type of the SIB requested to be transmitted, “requested-MBS-SIB-and-MCCH” indicating that transmission of both the MBS SIB and the MCCH is requested, and “requested-MCCH” indicating that transmission of the MCCH is requested. For example, when requesting transmission of “both MBS SIB and MCCH”, the UE 100 transmits the RRCSystemInfoRequest message including “requested-MBS-SIB-and-MCCH”. When requesting transmission of “MBS SIB only”, the UE 100 transmits the RRCSystemInfoRequest message including “requested-SI-List” indicating the MBS SIB. When requesting transmission of “MCCH only”, the UE 100 transmits the RRCSystemInfoRequest message including “requested-MCCH”. Note that each of “requested-MBS-SIB-and-MCCH” and “requested-MCCH” is configured as a 1-bit flag.

Note that one cell of the gNB 200 may include a plurality of MCCHs. Each MCCH may be associated with a different TMGI. The MCCHs may have different transmission periodicities. When one cell of the gNB 200 includes a plurality of MCCHs, “requested-MCCH” may be configured as a list with a plurality of bits. In this case, respective bits may be associated with the order in the MCCH list broadcasted by the MBS SIB (the order in which the gNB 200 has extracted only the MCCHs not broadcasted or only the on-demand MCCHs).

### OTHER EMBODIMENTS

The operation flows described above can be separately and independently implemented, and also be implemented in combination of two or more of the operation flows. For example, some steps of one operation flow may be added to another operation flow or some steps of one operation flow may be replaced with some steps of another operation flow.

In the embodiments and examples described above, an example in which the base station is an NR base station (i.e., a gNB) is described; however, the base station may be an LTE base station (i.e., an eNB) or a 6G base station. The base station may be a relay node such as an Integrated Access and Backhaul (IAB) node. The base station may be a DU of the IAB node. The user equipment may be a Mobile Termination (MT) of the IAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing the processes to be performed by the UE 100 or the gNB 200 may be integrated, and at least part of the UE 100 or the gNB 200 may be configured as a semiconductor integrated circuit (a chipset or an SoC).

Embodiments have been described above in detail with reference to the drawings, but specific configurations are not limited to those described above, and various design variation can be made without departing from the gist of the present disclosure.

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

1. A communication method performed by a user equipment in a mobile communication system for providing a multicast/broadcast service (MBS), the communication method comprising:
receiving, from a network node, configuration information by which a multicast traffic channel (MTCH) associated with an MBS radio bearer (MRB) is configured; and
determining that a data inactivity monitoring is applied to the configured MTCH, in response to the configuration information being transmitted via a radio resource control (RRC) Reconfiguration message,
wherein the data inactivity monitoring is processing by which an RRC connection of the user equipment is released depending on a certain period of inactivity in which communication with the network node is not performed.

2. The communication method according to claim 1, further comprising:
determining that the data inactivity monitoring is not applied to the configured MTCH, in response to the configuration information being transmitted via a multicast control channel (MCCH).

3. A user equipment (UE) used in a mobile communication system for providing a multicast/broadcast service (MBS), the user equipment comprising:
a receiver configured to receive, from a network node, configuration information by which a multicast traffic channel (MTCH) associated with an MBS radio bearer (MRB) is configured; and
a circuitry configured to determine that a data inactivity monitoring is applied to the configured MTCH, in response to the configuration information being transmitted via a radio resource control (RRC) Reconfiguration message,
wherein the data inactivity monitoring is processing by which an RRC connection of the user equipment is released depending on a certain period of inactivity in which communication with the network node is not performed.

4. The UE according to claim 3, wherein
the circuitry is configured to determining that the data inactivity monitoring is not applied to the configured MTCH, in response to the configuration information being transmitted via a multicast control channel (MCCH).

5. A processor for a user equipment (UE) used in a mobile communication system for providing a multicast/broadcast service (MBS), the processor comprising:
a receiver circuitry configured to receive, from a network node, configuration information by which a multicast traffic channel (MTCH) associated with an MBS radio bearer (MRB) is configured; and
a control circuitry configured to determine that a data inactivity monitoring is applied to the configured MTCH, in response to the configuration information being transmitted via a radio resource control (RRC) Reconfiguration message,
wherein the data inactivity monitoring is processing by which an RRC connection of the user equipment is released depending on a certain period of inactivity in which communication with the network node is not performed.

6. The processor according to claim 5, wherein
the control circuitry is configured to determining that the data inactivity monitoring is not applied to the configured MTCH, in response to the configuration information being transmitted via a multicast control channel (MCCH).

7. A non-transitory computer readable medium that stores computer program comprising instructions that, when the computer program is executed by a user equipment (UE), cause the UE to carry out the communication method according to claim 1.

8. A mobile communication system comprising: the UE according to claim 3; and a network node.
